(19) United States
(12) Patent Application Publication
(10) Pub. No.: US 2013/0064640 A1
(43) Pub. Date: Mar. 14, 2013

(54) PERFORATED HYDROCRATIC GENERATOR

(71) Applicants: Warren Finley, Mission Viejo, CA (US); Geoffrey Dolbear, Katy, TX (US); Anthony Jones, Sacramento, CA (US)

(72) Inventors: Warren Finley, Mission Viejo, CA (US); Geoffrey Dolbear, Katy, TX (US); Anthony Jones, Sacramento, CA (US)

(21) Appl. No.: 13/571,297

(22) Filed: Aug. 9, 2012

Related U.S. Application Data
(60) Provisional application No. 61/574,936, filed on Aug. 11, 2011.

(51) Int. Cl. F01K 27/00; F03B 11/02

(52) U.S. Cl. 415/1; 137/561 R

(57) ABSTRACT

A hydrocratic device comprises an inner pipe defining a mixing area, an outer pipe, and an annular chamber between the inner and outer pipes. A feed inlet supplies the annular chamber, and a plurality of perforations are formed in the wall of the inner pipe.

### CROSS REFERENCE TO RELATED APPLICATIONS

This application claims the benefit of U.S. Provisional Patent Application No. 61/574,936 filed on Aug. 11, 2011, the content of which is incorporated herein in its entirety.

### FIELD AND BACKGROUND OF THE INVENTION

This invention relates to a perforated hydrocratic generator. In one form, the invention is for a mixing device for deriving energy by bringing together aqueous solutions of different concentrations.

The perforated hydrocratic generator of the invention may be located in one source of water, such as an ocean, and facilitate the mixing of such water with an aqueous solution from another source, such as a brine feed source, to produce the energy. These sources are intended to be examples only, and the nature and combination of such water sources and their respective properties may be selectively chosen according to the nature of the circumstances from a wide variety of such potential sources.

### SUMMARY OF THE INVENTION

The basic technical concept behind the hydrocratic generator is the spontaneous mixing of two water streams that differ in their salinities, or other possible properties. Thermodynamics teaches us that when we contact two aqueous solutions with different concentrations of solutes, there is a driving force for the solutes from each solution to diffuse into the other until the concentrations are the same throughout the combined liquid which results there from. The energy driving this mixing is described by thermodynamics as the free energy of mixing, and that energy is mostly contributed by the entropy of mixing. That driving force can usually be calculated from thermodynamic equations which are well known and date back to the late 19th century.

One recognized and well-known example of that driving force in action is the process of osmosis. However, the osmotic process is generally slow, and this is because of the slow diffusion of material back through the membrane provided for separating the two liquids. One aspect of the present invention is therefore to derive a way to cause that mixing to take place much faster, and fast enough, in fact, to generate a moving stream of water. Various experiments which have been carried out in this regard all show that the hydrocratic generator makes it possible to mix about 30 volumes of sea water with 1 volume of fresh water in just a few seconds. Note that this is one possible ratio only, and others may fall within the scope of the invention based on the exigencies of the different sources which are being mixed together.

### BRIEF DESCRIPTION OF THE DRAWINGS

In the drawings:

FIG. 1 is a schematic representation of a hydrocratic generator in accordance with one aspect of the present invention, the hydrocratic generator being located below an ocean surface; and

FIG. 2 is a schematic representation of a hydrocratic generator in accordance with a further aspect of the present invention, the hydrocratic generator once more being located below an ocean surface.

### DETAILED DESCRIPTION OF THE INVENTION

The perforated hydrocratic device according to one aspect of the present invention takes the design of these devices to another level. As illustrated in the accompanying schematic representations, fresh water from, for instance but not limited to, a sewage treatment facility, is led into the perforated hydrocratic device of the invention which may be submerged in sea or ocean water, but which may also of course be salt water in a bay or inland sea. By fresh water is meant water with salinity much less than found in the sea water (which is typically 3.4 wt %).

Instead of being directed into the open bottom end of a vertical pipe (generally termed the “up tube” for ease of reference), the fresh water may enter an annular pipe or vessel surrounding an open vertical pipe. The outer vessel serves as a plenum chamber or an enclosed space configured for the purpose of distributing the entering fresh water around the vertical pipe and along its length. Preferably, the distribution of the entering fresh water in the plenum chamber facilitates the mixing process with the water moving through the vertical pipe. It does not matter for the broad purposes of the present invention whether the fresh water enters the plenum near the bottom, in the middle or near the top of the plenum, or at any place in between, or at multiple selected entry points, because the plenum chamber itself acts to distribute the fresh water more or less evenly throughout its volume or space.

The inner wall of the plenum, which corresponds to the outer wall of the up tube, is preferably perforated by a plurality of holes which allow the fresh water to flow from the plenum chamber into the salt water which is in the inside the up tube. The fresh water and salt water will mix inside the up tube at the several or many points where the fresh water enters the up tube to create the mixture, as well as in the spaces generally defined by the up tube. Having these many initial mixing points will ensure that mixing is efficient and broad-based, and will thus preferably allow the combined volume of the mixture leaving the top of the up tube to be very large. Large volumes translate into increased power generation from, for example, the propeller-like device that is attached to the upper (exit) end of the up tube. The invention is not limited to the use of a propeller, but any other device such as a turbine may be used to generate the energy. Note that the propeller or other type device for power generation may also be located at the lower end of the up tube, as may be appropriate in the circumstances, some of which are described below.

The exact design and placement of the holes for passage of fluid between the annular plenum and the up tube can be varied in a number of acceptable ways within the scope of the invention. In one simple embodiment of the many possibilities, the holes will be all the same size and more or less evenly distributed around the perimeter and along the length of the up tube. However, it may be advantageous in certain applications to have more holes at the top rather than the bottom of the up tube, or vice versa. Another variation is that the holes at the bottom, or at some point along the up tube, may be larger than those at the top or elsewhere on the up tube. A further option is to have certain selected or all of the holes drilled through the wall at some kind of angle to cause the water flowing upward to turn in a “spin” or in a spiral fashion, or increase turbulence, all of which may possibly have the consequence of improving the mixing further. The holes may, for example, be simply drilled straight through the wall or they may be designed with a constriction about halfway through the wall, forming a tiny venturi nozzle (see http://en.wikipedia.org/wiki/Venturi effect) that would have the effect of increasing mixing while keeping the holes clean and free from deposits, etc.

It may also desired to fashion the holes as little slots rather than round holes. As will therefore be appreciated, the holes may take many different forms, sizes and configurations, and there may be a mix of such holes, in any desired combination of sizes and shapes and numbers, in any one device. The number and selection and placement of the holes and their respective configurations is therefore quite varied, and may be chosen based on the peculiarities and ambient characteristics of the specific environment in which they are located.

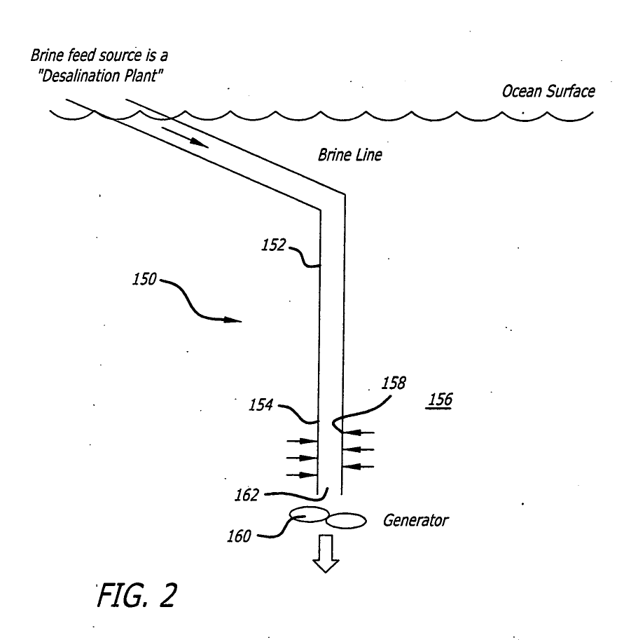

It should also be appreciated that the entire design could be used to mix a brine (a salt solution where the salt content is markedly higher than in sea water) into sea water. Here, the detailed design would be similar but not necessarily the same. It may not matter in this particular context whether the brine enters the annular plenum chamber near the bottom or near the top thereof (or at any intermediate location), since the plenum preferably itself acts to distribute the brine fairly uniformly along the flowing sea water on the inside. Of course, the inner volume would now be referred to as a “down tube” and the energy device (such as a propeller or turbine) positioned so as to capture the energy produced by the system would be placed at the lower exit end, as seen in the embodiment illustrated in FIG. 2 of the drawings.

Generator using the ocean as a plenum: There are many options and configurations of the device which may be used in this particular application. In one form of the invention, brine from a desalinization plant is provided by a pipe, and the mixing in this hydrocratic generator occurs in the modified end of that pipe. In essence, the ocean acts as the plenum chamber in the invention discussed above. Holes located in the wall of the tube provide the flow from the ocean to the entering brine, and the mixed solutions exit through the open bottom of the tube. The diameter of the tube may be adjusted for efficiency. Again, the design and placement of the holes can be designed in such a way to optimize mixing volumes, and again a power generator can be attached to the open exit end.

It will be appreciated that this design as described herein could be used for generating power from fresh or waste water by placing a “U-bend” in the supply tube upstream from the mixing zone, performing the mixing in the upward vertical section, and the like.

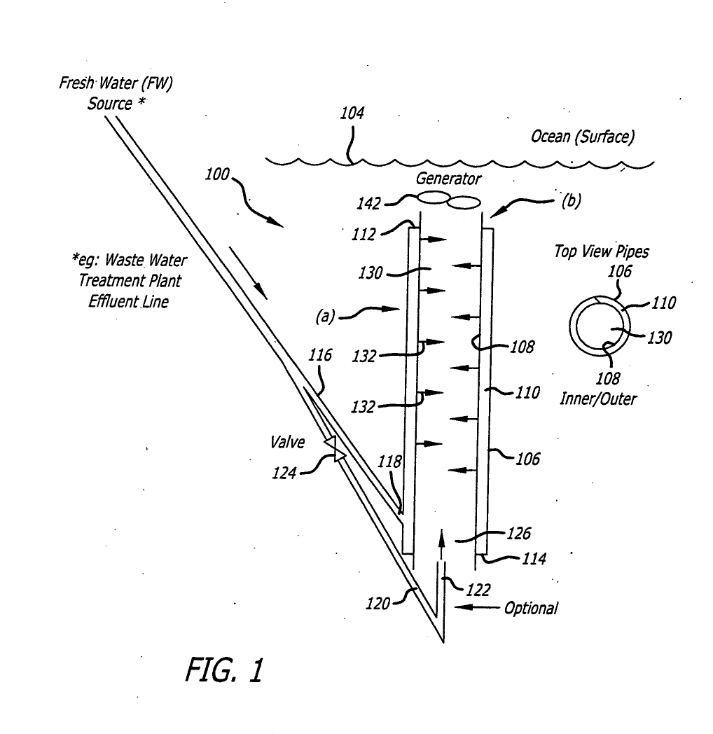

One embodiment of the perforated hydrocratic generator 100 of the invention is shown in FIG. 1 of the accompanying drawings, which shows an ocean volume portion 102 below the ocean surface 104. The generator of the invention 100 comprises an outer pipe 106 and an inner pipe 108. The outer pipe 106 and inner pipe 108 are substantially concentric (although this is not necessary) and substantially coaxial relative (although this is not necessary) to each other and define an annular space 110 therebetween.

The annular space 110 has a closed top end 112 and a closed bottom end 114. A fluid inlet pipe 116 is provided and the outer pipe 106 has an opening 118 so that fluid from the fluid inlet pipe 116 can enter the annular space 110. The fluid inlet pipe 116 may convey fluid from any of a number of sources, such as a fresh water source, which may be from a wastewater treatment plant. The fluid inlet pipe 116 may therefore comprise, for example, a wastewater treatment plant effluent line. This is just one example of many which can be used within the scope of the present invention.

The fluid inlet pipe 116, which may also be termed the effluent line, may have a branched portion 120 with an upwardly directed end 122. Flow of fluid into the branched portion 120 is preferably controlled by a valve 124 to selectively permit fluid to pass therethrough. When the valve 124 is open, fluid from the fresh water source will also be discharged into the space below the lower end 126 of the inner pipe 108. In this arrangement, therefore, freshwater will enter the inner pipe 108 through both the end 122 and through holes in the inner pipe 108, as will be described.

The inner pipe 108 defines a mixing area 130 where the different sources of water each having different salinities are mixed in a controlled manner. Furthermore, the inner pipe 108 is provided with a plurality of holes 132 which permit fluid in the annular space 110 to enter the mixing area 130. In the mixing area 130, the fluid from the ocean, which is able to enter the mixing space 130 from the bottom end 126, as well as the top end 140, is able to mix with the water from the freshwater source discharged into the mixing area 130 through the plurality of holes 132, as well as, selectively, from the pipe 122. As discussed above, these two aqueous solutions with different concentrations of solutes and salinities produce energy, and this energy may be captured by the generator 142 which is strategically located at about the upper end 140 of the inner pipe 108. Of course, a corresponding or alternative generator may be located at the lower end 126 of the device 100, in other embodiments.

FIG. 1 thus shows the configuration where the inner pipe is perforated with holes, and the outer pipe is solid with a closed off top and bottom to create the enclosed annular space 110. Fresh water has access to the holes in the inner pipe. The volume of water in the inner pipe increases, thus increasing both velocity as well as kinetic energy.

In FIG. 2 of the drawings, a different embodiment of the invention is illustrated. The perforated hydrocratic generator 150 comprises a pipeline 152, conveying, for example, brine feed from a desalination plant through the pipe 152. The end 154 of the pipe 152 is located in the ocean 156, and has a plurality of perforations or holes 158 form near its lower end, at least beneath the ocean surface. The pipe 152 has an open end 162. In this embodiment of the invention, ocean water passes through the perforations 158, and mixes with the brine feed source flowing through the pipe 152, which generates energy that may be captured by a generator 160, which is appropriately positioned in the manner generally described above.

As an example, doubling the volume of water passing through the tube 152 in a given amount of time may quadruple the amount of energy produced. In this regard, the following formula or may be applied:

E=MV²/2

In one embodiment, the pipe is perforated with holes, or a screen may be provided, at or near the lower end. The ocean water accesses or enters the pipe through these holes. The volume of the water in the pipe increases, thereby increasing both velocity and kinetic energy.

According to one aspect of the invention, there is provided a perforated hydrocratic device comprising an inner pipe, an outer pipe, and an annular chamber between the inner and outer pipes, a feed inlet to the annular chamber, and a plurality of perforations in the wall of the inner pipe. In one form, the inner pipe is open at both ends thereof. A power generator may be located at either one or both of such ends.

The perforated hydrocratic device may be located in the ocean, and the feed inlet provides fluid of different salinity from another source.

Preferably, the annular chamber is closed so that fluid therein exits into the space defined by the inner pipe through the plurality of perforations.

In one embodiment of the invention, the feed inlet may have a branched portion for discharging a part of the aqueous solution therein into the space defined by the inner pipe, either at the upper or lower end thereof. The branched portion may be controlled by a valve so that such discharge into the inner pipe may be selectively controlled.

In another aspect of the invention, there is provided a perforated hydrocratic generator comprising a line formed by a pipe, the pipe conveying an aqueous solution from one source, the pipe having a plurality of perforations near a location thereof which is situated in a different aqueous solution, the perforations facilitating flow of the aqueous solution outside the pipe into the pipe through the perforations for mixing of the aqueous solutions from the different sources. A generator may be provided to capture energy produced as a result thereof.

According to yet a further aspect of the invention, there is provided a method for generating energy using a hydrocratic device, the method comprising: providing an open ended inner pipe defining a mixing area, the inner pipe having a plurality of perforations therein, the inner pipe being located in a first aqueous solution; locating an outer pipe substantially coaxially and concentric around the inner pipe such that the inner pipe and the outer pipe for a closed chamber; feeding a second aqueous solution through a supply tube into the closed chamber, such that the second aqueous solution is able to pass through the plurality of perforations and mix with the first aqueous solution in the inner pipe; and capturing energy produced by the mixing of the first and second aqueous solutions.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A hydrocratic device comprising an inner pipe defining a mixing area, an outer pipe, an annular chamber between the inner and outer pipes, a feed inlet to the annular chamber, and a plurality of perforations in the wall of the inner pipe.

2. A hydrocratic device as claimed in claim 1 wherein the inner pipe is open at both ends thereof.

3. A hydrocratic device as claimed in claim 2 further comprising a power generator located at either one or both of such ends.

4. A hydrocratic device as claimed in claim 1 wherein the hydrocratic device is located in ocean water, and the feed inlet provides fluid of different salinity from another source for mixing with the ocean water.

5. A hydrocratic device as claimed in claim 1 wherein the annular chamber is closed at both ends thereof so that fluid therein exits into the mixing area defined by the inner pipe through the plurality of perforations.

6. A hydrocratic device as claimed in claim 1 wherein the feed inlet comprises a branched portion for discharging a part of an aqueous solution therein into the mixing area defined by the inner pipe.

7. A hydrocratic device as claimed in claim 7 wherein the branched portion discharges into the upper end of the inner pipe.

8. A hydrocratic device as claimed in claim 7 wherein the branched portion discharges into the lower end of the inner pipe.

9. A hydrocratic device as claimed in claim 7 further comprising a valve to selectively control the discharge from the branched portion.

10. A hydrocratic device as claimed in claim 1 wherein the plurality of perforations are circular holes.

11. A hydrocratic device as claimed in claim 1 wherein the plurality of perforations have one or more of the following shapes: circular, square, elliptical, rectangular.

12. A hydrocratic device as claimed in claim 1 wherein at least some of the plurality of perforations are angled in the inner pipe.

13. A hydrocratic device as claimed in claim 1 wherein at least some of the plurality of perforations comprise constrictions therein for creating a Venturi effect.

14. A hydrocratic device as claimed in claim 1 wherein the number of perforations in the inner pipe are different at different positions on the inner pipe.

15. A hydrocratic device as claimed in claim 1 wherein the size of the perforations in the inner pipe are different at different positions on the inner pipe.

16. A hydrocratic device comprising a line formed by a pipe, the pipe conveying a first aqueous solution from one source, the pipe having a plurality of perforations near a location thereof which is situated in a second aqueous solution, the perforations facilitating flow of the second aqueous solution outside the pipe into the pipe through the perforations for mixing of the first and second aqueous solutions from the different sources.

17. A hydrocratic device as claimed in claim 16 further comprising a generator positioned to capture energy produced as a result of the mixing of the first and second aqueous solutions.

18. A hydrocratic device as claimed in claim 16 wherein the size, shape and density of the perforations made each very at different locations on the inner pipe.

19. A method for generating energy using a hydrocratic device, the method comprising:
providing an open ended inner pipe defining a mixing area, the inner pipe having a plurality of perforations therein, the inner pipe being located in a first aqueous solution;
locating an outer pipe substantially coaxially and concentric around the inner pipe such that the inner pipe and the outer pipe defined a closed chamber therebetween;
feeding a second aqueous solution through a supply tube into the closed chamber, such that the second aqueous solution is able to pass through the plurality of perforations and mix with the first aqueous solution in the inner pipe; and
capturing energy produced by the mixing of the first and second aqueous solutions.

20. A method as claimed in claim 19 wherein the size, density, shape and configuration of the perforations are different at different positions along the inner pipe.

21. A method as claimed in claim 19 wherein the energy is captured by a propeller or turbine which is located at one or both of the open ends of the inner pipe.

22. A method as claimed in claim 19 wherein the inner pipe is oriented in a substantially vertical position in the first aqueous solution.
